(19) United States
(12) Patent Application Publication
(10) Pub. No.: US 2018/0197259 A1
(43) Pub. Date: Jul. 12, 2018

(54) CREATION AND EXECUTION OF DRILLS

(71) Applicant: Margaret C. Knopic, Los Angeles, CA (US)

(72) Inventor: Margaret C. Knopic, Los Angeles, CA (US)

(21) Appl. No.: 15/401,043

(22) Filed: Jan. 8, 2017

(51) Int. Cl. G06Q 50/20; G09B 5/00; G09B 9/00; G09B 19/00; G09B 7/00

(52) U.S. Cl. CPC G06Q 50/2057; G09B 5/00; G09B 7/00; G09B 19/003; G09B 19/00; G09B 9/00

(57) ABSTRACT

Provided are a method and a system for creation and execution of drills. The method may commence with receiving drill parameters from an administrator. The method may further include generating a drill based on the drill parameters and generating an access code associated with the drill. The method may further include providing the access code to the administrator to be disseminated by the administrator to one or more users. Furthermore, the method may include receiving a request from a user of the one or more users. The user may provide the request by sending the access code via a user device. Responsive to the request, the drill associated with the access code may be provided to the user via the user device for an execution of the drill by the user. The method may further include collecting data associated with the execution of the drill by the user.

### TECHNICAL FIELD

This invention relates generally to data networks and more particularly to creation and execution of drills.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

Trainings for employees in organizations may have enormous importance for staff management and education. Conventionally, organizations deliver trainings to employees in the form of written instructions, guides, video presentations, or any other forms of corporate education. Every organization may choose its own methodology and approaches for educating and training the employees. Some of the applied approaches relate to use of oral trainings followed up by written instructions. However, such approaches may be time- and labor-consuming. In fact, the organization may need to find or hire a specialist to conduct the training in a specific area of knowledge, gather different groups of people separately, print instructions, and conduct quizzes to estimate the level of technology knowledge. Thus, the organization may spend many man hours developing and conducting trainings and analyzing results of the trainings performed by the employees. Additionally, planning of such training-related events on a weekly, monthly, or yearly basis may take time and human resources.

The modern level of technology allows automating such training processes by means of online creation of exercises for employees. The online creation of the exercises may significantly reduce human and time resources needed. Moreover, providing online education to the employees may simplify delivery of trainings to the employees and gathering the results of training performance. However, in the case of a big organization having thousands of employees, persons responsible for scheduling a training for a group of employees may need to browse through a number of pages of training information on a web portal containing all trainings of the organization to find and select a specific training. Additionally, the persons responsible for the creation of the drill may need to set up meetings to discuss and plan the drills.

Conventional drills and exercises specific to the nuclear industry, as well as government level drills and military drills, are all done in a form of binders of printed and assembled text documents and portable document format (PDF) documents. Therefore, each person participating in a drill has many documents, some of which the person completes during the drill for grading and some of which are intended for note taking. After completion of the drill, all these documents have to be compiled and sent to a regulatory organization responsible for monitoring drill creation and execution, such as the Nuclear Regulatory Commission (NRC). However, setting and attending meetings, printing and populating the documents among the persons, and further collecting and sending the documents to the regulatory organization may be time- and resource-intensive.

Furthermore, if an organization is an emergency response facility, the trainings may need to be delivered in the fastest way possible and according to a predetermined procedure of emergency actions to protect health and safety of the public.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to approaches for creation and execution of drills. According to one approach of the present disclosure, a system for creation and execution of drills is provided. Specifically, the system may include a drill creation unit, a drill execution unit, a processing unit, and a storage unit. The drill creation unit may be operable to receive, from an administrator, via an administrator device, drill parameters. Based on the drill parameters, the drill creation unit may generate at least one drill. The drill creation unit may further generate an access code associated with the at least one drill. The drill creation unit may provide the access code associated with the at least one drill to the administrator to be disseminated by the administrator to one or more users. The drill execution unit may be operable to receive, via a user device, a request from a user of the one or more users. The request may include providing, by the user, the access code associated with the at least one drill. Responsive to the request, the drill execution unit may provide the at least one drill associated with the access code to the user via the user device for an execution of the at least one drill by the user. The processing unit may be operable to collect data associated with the execution of the at least one drill by the user. The storage unit may be operable to store at least the drill parameters, the at least one drill, and the access code.

According to another approach of the present disclosure, a method for creation and execution of drills is provided. The method may commence with receiving, by a drill creation unit, via an administrator device, drill parameters from an administrator. The method may further include generating, by the drill creation unit, at least one drill based on the drill parameters. The method may continue with generating, by the drill creation unit, an access code associated with the at least one drill. The method may further include providing, by the drill creation unit, the access code associated with the at least one drill to the administrator to be disseminated by the administrator to one or more users. Furthermore, the method may include receiving, by a drill execution unit, a request from a user of the one or more users. The request may be provided by the user via a user device by sending the access code associated with the at least one drill. Responsive to the request, the at least one drill associated with the access code may be provided to the user via the user device for an execution of the at least one drill by the user. The method may further include collecting, by a processing unit, data associated with the execution of the at least one drill by the user.

In further example embodiments of the present disclosure, the method operations are stored on a machine-readable medium comprising instructions, which, when implemented by one or more processors, perform the recited operations. In yet further example embodiments, hardware systems or devices can be adapted to perform the recited operations. Other features, examples, and embodiments are described below.

### BRIEF DESCRIPTION OF THE DRAWINGS

Embodiments are illustrated by way of example, and not by limitation, in the figures of the accompanying drawings, in which like references indicate similar elements.

FIG. 1 shows an environment, within which methods and systems for creation and execution of drills can be implemented.

FIG. 2 a block diagram illustrating a system for creation and execution of drills, according to an example embodiment.

FIG. 3 shows a flow diagram depicting a method for creation and execution of drills, according to an example embodiment.

FIG. 4 illustrates a user interface for displaying a list of drills associated with an administrator, according to an example embodiment.

FIG. 5 illustrates a user interface for creation of a drill by an administrator, according to an example embodiment.

FIG. 6 is a schematic diagram illustrating a user interface for creation of an event associated with a drill, according to an example embodiment.

FIG. 7 illustrates a user interface showing a list of events associated with a drill, according to an example embodiment.

FIG. 8 illustrates a user interface showing events of a drill, according to an example embodiment.

FIG. 9 illustrates a user interface showing a drill execution report, according to an example embodiment.

FIG. 10 shows a diagrammatic representation of a computing device for a machine, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits, programmable logic devices, or various combinations thereof. In particular, the methods described herein may be implemented by a series of computer-executable instructions residing on a storage medium, such as a disk drive or computer-readable medium. It should be noted that methods disclosed herein can be implemented by a computer (e.g., a desktop computer, a tablet computer, a laptop computer), a cellular phone, a smart phone, a smart television system, and so forth.

As outlined in the summary, the embodiments of the present disclosure are directed to creation and execution of drills. A system for creation and execution of drills as described herein may be a tool for creating and executing drills, such as emergency preparedness exercises. More specifically, the system may help an organization to move away from spending man hours on typing text documents (e.g., a Microsoft Word document) or making PDF documents, spending time on printing and assembling documents into binders, and after a drill is performed, collecting result data and putting the result data back into a different text document or PDF document, printing the documents containing the result data, and sending the documents to a regulatory authority, such as the NRC.

The system may include a web portal being a drill administration tool for an administrator and an application running on mobile devices of a plurality of users. The administrator may include a person of an organization responsible for creating and managing drills of the organization and collecting results of drill performance by the users. In some embodiments, the administrator may include multiple persons each having access to creating and managing drills and collecting results of drill performance. The users may include employees of the organization or any other groups of persons intended to perform the drills. A drill may include a step-by-step instruction or a set of exercises to be performed by a user to practice skills of the user, train actions to be performed by the user under specific conditions or in case a specific event occurs, study specific information related to equipment, possible events, regulatory procedures, evaluate adherence of the user to a specific procedure, and the like. The drill may include a weekly training drill, a monthly training drill, regulated graded exercises, a large-scale drill for all users of the organization, a mini-scenario for a specific group of users, an emergency management drill, a fire drill, an elementary school drill, a hospital drill, a drill associated with one organization, such as a nuclear drill for a nuclear plant, a drill associated with multiple municipalities, a drill to be performed in a specific area or a specific location, and so forth. Additionally, the drill may be intended to provide a simulation of a specific event for the users and grade actions of the users performed during the simulated event. The grading may be associated with assessing whether the users follow a predetermined procedure associated with a specific event, assessing whether the users use knowledge associated with a plant to assist in an emergency, and the like.

The web portal may provide a two-level access to the system. More specifically, an owner of the system, e.g., a developer of the system or a person that gained the right to use unlimitedly all resources and features of the system, may have a first level of access. The first level of access may enable the owner to grant administrators an access to the system. The administrators may be associated with organizations or authorities, which want to use the system for creating and executing specific drills related to those organizations or authorities. In fact, the administrators may be a client of the owner and may request to use the system. In some embodiments, an administrator may access a home page of the web portal and request to create a profile associated with the administrator. Upon request, the profile may be created for the administrator. The administrator may need to pay a one-time predetermined fee, a predetermined subscription fee, or may be granted a free trial period for using the system.

In some embodiments, the owner may add data provided by the administrator in the profile into a database to grant the administrator access to the system. In other embodiments, upon creation of the profile, the data provided by the administrator in the profile may be automatically stored into the database and the access to the system may be automatically granted to the administrator. Once the administrator is granted the access to the system, such steps as creation of drills, editing of the drills, publishing of the drills, assessment logs related to the execution of the drills, reporting related to results of the execution of the drills, and evaluation of the execution of the drills may be available for the administrator.

In particular, the administrator may start working on the creation of drills by entering detailed information associated with the drill, such as a name, a date, and events associated with the drill, and objective templates that determine what evaluation criteria need to be utilized to assess the drill after the drill is performed by the users. While all the steps necessary to create the drill are performed by the administrator via the web portal, the execution of the drill may be performed by one or more users via mobile devices associated with the users. The application associated with the system may be installed and running on the mobile devices and may be in communication with the database of the system. In other words, the drills may be provided to the users via the mobile devices.

The administrator may perform the following steps during the creation of the drills. The administrator may open a sign-in page associated with the web portal and enter credentials associated with the administrators, such as a username and a password. Upon receipt of the credentials by the system, a user interface representing a home screen may be provided to the administrator. The home screen may provide the administrator with an access to all previously created drills and may provide a tool for creating new drills. The administrator may enter objective templates to classify specific objectives for each exercise of the drill and consolidate findings associated with results of drill execution into a customized report. More specifically, the objective templates may include metrics and evaluation criteria to be utilized to assess the execution of the drills and to allow the administrator to grade effectiveness of the drill, performance of the drills by the users, and the overall ability of the users to perform the drill correctly.

When the administrator selects on option to create a drill, the administrator may enter a name of the drill, a date and time for the execution of exercises of the drill, and events associated with the drill. The events may include information associated with the drill, such as description, specific details, a name of a person who created the drill, a message associated with the drill, a response expected to be received from the users during execution of the drill, actions to be performed by the administrator or the users, and so forth. The administrator may modify the drill later by deleting or adding information or events associated with the drill.

Risks associated with planning standards may be tracked in real-time during the drill by supplying the information into the web portal. The specific severity, Emergency Action Level (EAL), Protective Action Recommendations (PAR), and other schemes may be programmed into the web portal to track the studies of the ability of the emergency response organization to meet regulatory requirements.

Upon entering all required information related to the drill, the drill may be generated and all data entered by the administrator may be exported into a spreadsheet, thereby streamlining briefs and reports associated with the drills. The generated drill may be electronically stored in a storage unit.

Upon creation of the drill, the administrator may request to activate the execution of the drill. Upon receipt of an activation request from the administrator, an access code may be generated for the drill. The administrator may disseminate the generated access code to one or more users intended to perform the drill. For example, the access code may be sent to the intended users via e-mail, or the access code may be sent to an organization network associated with the administrator and may be accessed by the users of the organization network.

Upon receipt of the access code associated with the drill, the user may open the application running on the mobile device of the user. Upon opening the application, the user may be prompted to enter the access code. Upon receipt of the access code, the user may be further prompted to enter user credentials. In an example embodiment, the user credentials may be provided by the user during the registration of the user in the system upon the first launch of the application on the mobile device.

Upon receipt of the user credentials, a home screen of the drill associated with the access code entered by the user may be provided to the user. The home screen of the drill may display a timeline of events of the drill. Each event may be associated with an exercise to be performed by the user. The user is allowed to make free text notes for every event of the drill and any point of the exercise. The user may select a specific event, such as an event associated with a current time, and may perform the exercises of the event.

Results of execution of the drill by each of the intended users who received the access code related to the drill may be collected and provided to the administrator. The results of execution of the drill may be presented, for example, in a form of a table containing a name of the user, a time of the drill, and log data associated with the drill, such as answers of the user provided during the execution of the drill, free text notes made by the user, grades provided by the administrator who monitored the execution of the drill by the user, and so forth.

The results may be exported into a file for further review and analysis. The file may be an editable document in any required document format, such as Microsoft Word, Microsoft Excel, PDF, and so forth. Thus, man hours needed to create the drill and collect the results of execution of the drill may be minimized and completion of the drill report may be expedited.

Upon termination of the drill, i.e., when the intended users executed the drill, the administrator may request to deactivate the drill to make the drill unavailable for the users. In response to a deactivation request, the access code may be set to be invalid and the users may not have access to the drill.

The drills created and executed using the system of the present disclosure may not only be a regulatory requirement to be fulfilled by the organization to train and educate the employees, but may also be a diagnostic tool used to constantly improve the capabilities of the organization and determine the level of readiness of the organization for emergency situations.

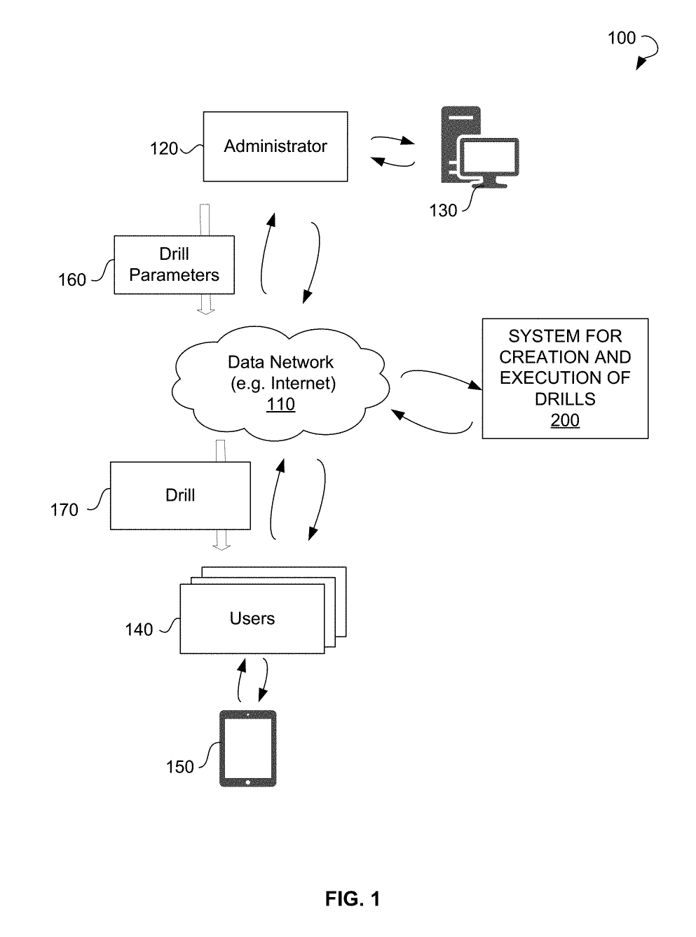

Referring now to the drawings, FIG. 1 illustrates an environment 100 within which methods and systems for creation and execution of drills can be implemented. The environment 100 may include a data network 110, an administrator 120, an administrator device 130 associated with the administrator 120, one or more users 140, user devices 150 associated with each of the users 140, and a system 200 for creation and execution of drills also referred to as a system 200. The user devices 150 may include a personal computer (PC), a laptop, a smartphone, a tablet PC, a personal wearable device, and so forth. The administrator device 130 may include a PC, a laptop, a smartphone, a tablet PC, a personal wearable device, and so forth. The user devices 150 and the administrator device 130 may be connected to the data network 110.

The data network 110 may include the Internet, a computing cloud, and any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of Recommended Standard 232 (RS-232) serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking. The data network may include a network of data processing nodes, also referred to as network nodes, that are interconnected for the purpose of data communication.

The systems and methods describe herein may also be practiced in a wide variety of network environments (represented by the data network 110) including, for example, Transmission Control Protocol/Internet Protocol-based networks, telecommunications networks, wireless networks, and the like. In addition, the computer program instructions may be stored in any type of computer-readable media. The program may be executed according to a variety of computing models including a client/server model, a peer-to-peer model, on a stand-alone computing device, or according to a distributed computing model in which various functionalities described herein may be effected or employed at different locations.

The administrator 120 may enter drill parameters 160 using the administrator device 130. The system 200 may receive the drill parameters 160 and may generate a drill 170 based on the drill parameters 160. The drill 170 may be provided to the users 140. More specifically, the users 140 may access the drill 170 using the user devices 150.

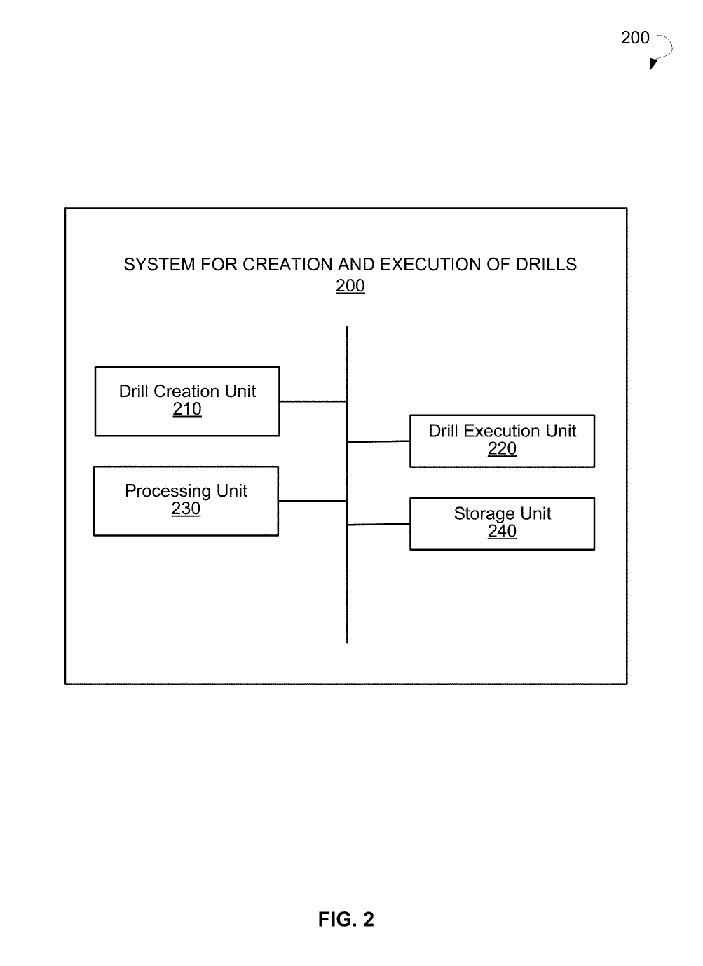

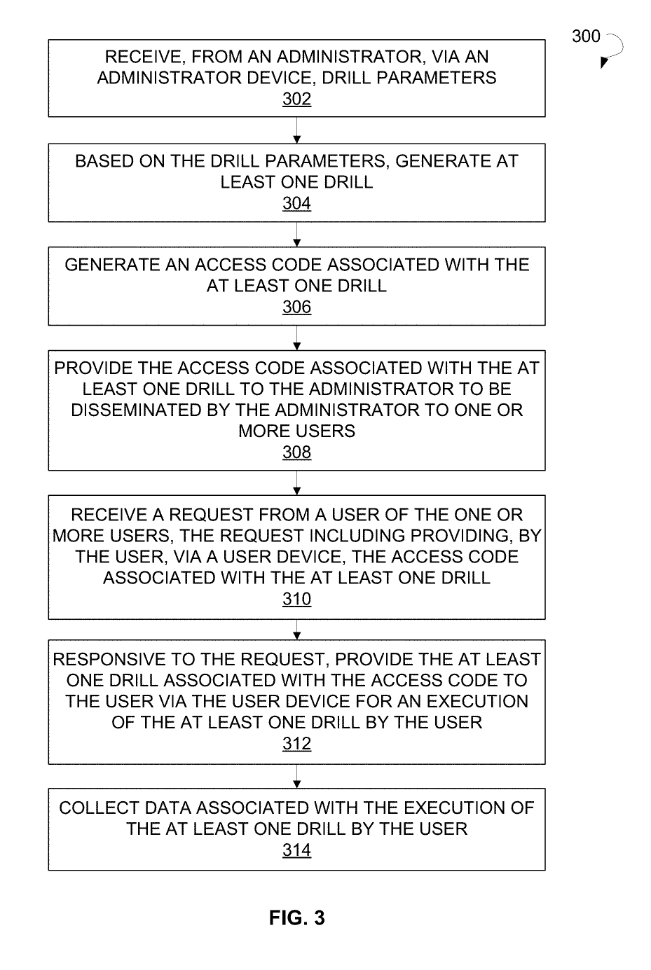

FIG. 2 is a block diagram showing various modules of a system 200 for creation and execution of drills, in accordance with certain embodiments. Specifically, the system 200 may include a drill creation unit 210, a drill execution unit 220, a processing unit 230, and a storage unit 240. The processing unit 230 may include a programmable processor, such as a microcontroller, a central processing unit, and so forth. In example embodiments, the processing unit 230 may include an application-specific integrated circuit or programmable logic array designed to implement the functions performed by the system 200. Operations performed by each of the drill creation unit 210, the drill execution unit 220, the processing unit 230, and the storage unit 240 are described below with reference to FIG. 3.

FIG. 3 is a flow chart illustrating a method 300 for creation and execution of drills, in accordance with certain embodiments. The method 300 may commence with receiving, by a drill creation unit, via an administrator device, drill parameters from an administrator at operation 302. More specifically, a user interface may be provided to the administrator on a display of the administrator device. The administrator may enter the drill parameters into fields displayed on the user interface. In an example embodiment, the drill parameters may be received by receiving one or more documents associated with at least one drill. More specifically, the administrator may upload the one or more documents using the administrator device. The one or more documents may be uploaded from the administrator device, a cloud network, a storage unit, and so forth. The drill parameters may include one or more of the following: a name associated with the at least one drill, a description associated with the at least one drill, a date for the execution of the at least one drill, an event associated with the at least one drill, a message associated with the at least one drill, objective templates associated with the at least one drill, criteria for grading objectives associated with the objective templates, and so forth. In some example embodiments, the criteria for grading may be predetermined grading criteria or may be provided by the administrator. In an example embodiment, the administrator may provide the objective templates during a one-time setup for all drills so as to classify the specific objectives during each exercise and consolidate findings of the execution of drills into a customized drill execution report. In another example embodiment, the objective templates may be provided for each specific drill. In a further example embodiment, the administrator may upload photo and/or video files as the description of the drill to ensure that the users perform the elements of the exercises of the drill with the utmost fidelity.

The method 300 may continue with generating, by the drill creation unit, the at least one drill at operation 304. The at least one drill may be generated based on the drill parameters. The at least one drill may be intended to develop skills associated with manipulation of an equipment, develop decision-making abilities of the one or more users, schedule actions to be performed by the one or more users, study information by the one or more users, practice actions by the one or more users, prevent injury to employees of the organization, prevent failure of plant equipment, and so forth.

The method 300 may further include operation 306, at which the drill creation unit may generate an access code associated with the at least one drill. The access code may be generated upon generation of the at least one drill. The access code may include a unique numeral, literal, or symbolic passcode generated for every drill. When combined with a personal passcode (a numeral, literal, and/or symbolic passcode, an unlock pattern, a fingerprint passcode, and the like) usually used by the users for the user devices, the access code may assure a two-barrier protection against any security violations related to execution of the drills.

Upon generation of the access code, the drill creation unit may provide the access code associated with the at least one drill to the administrator at operation 308. Upon receipt of the access code, the administrator may disseminate the access code to one or more users. The access code may be disseminated by the administrator by one or more of the following ways: sending the access code via e-mail to the one or more users, sending the access code to an organization network associated with the administrator and the one or more users, enabling the administrator to provide the access code to the one or more users, providing the access code via an announcement board of an organization associated with the administrator and the one or more users, providing the access code via a messaging agent associated with the organization, and so forth.

In an example embodiment, the method 300 may include receiving, by the drill creation unit, an activation request to activate the at least one drill. The activation request may be provided by the administrator. In this embodiment, the access code may be generated based on the activation request.

The method 300 may further include receiving, by a drill execution unit, a request from a user of the one or more users at operation 310. The user may send the request by providing, via a user device, the access code associated with the at least one drill. In an example embodiment, upon receipt of the access code from the user, the drill execution unit may prompt the user to enter authentication information associated with the user. The authentication information may include at least credentials associated with the user.

Upon receipt of the request from the user, the drill execution unit may provide the at least one drill associated with the access code to the user at operation 312. The at least one drill may be provided via the user device for an execution of the at least one drill by the user. In an example embodiment, the at least one drill may include one or a plurality of exercises to be performed by the user. In a further example embodiment, the at least one drill may include a drill package including a plurality of drills to be executed by the user.

The use of user devices for providing the drills to the users and execution of the drills by the users prevents late participants, i.e., the users, to drill data and compromising elements of exercises of the drills. More specifically, in an organization where many persons are exposed to the standard elements of an exercise, preconditioning may occur. When the users are aware of the physical structure of drill and exercise packages, then their observation of behavior may lead to the compromise of certain elements of the exercise.

The method 300 may continue with collecting, by a processing unit, data associated with the execution of the at least one drill by the user at operation 314. In an example embodiment, the data associated with the execution of the at least one drill by the user may be collected by tracking the user using a tracking device. The tracking device may include the user device to track the user using location services associated with the user device, such as Global Positioning System data, Global System for Mobile Communications data, Wi-Fi data, and so forth. Furthermore, the tracking device located in the area where the drill is performed may be used, such as cameras, sensors, and the like. In a further example embodiment, the execution of the drill by the user may be visually monitored by the administrator or a controlling person assigned by the administrator. The administrator may grade the performance of the user and take notes and may enter grading data and the notes using the administrator device.

In a further example embodiment, the collected data may include logged activity of the user, such as an order of buttons pressed by the user during the exercises, answers to questions entered by the user, notes taken by the user during the execution of the exercise, and so forth.

In an example embodiment, the method 300 may include generating, by the processing unit, a drill execution report. The drill execution report may be generated based on the data associated with the execution of the at least one drill by each of the one or more users. Upon the generation of the drill execution report, the processing unit may provide the drill execution report to the administrator. The administrator may access the drill execution report via the administrator device.

The method 300 may further include analyzing, by the processing unit, the data associated with the execution of the at least one drill by each of the one or more users. The analysis may be performed based on predefined rules. The analysis may include tracking performance indicators associated with the execution of the at least one drill by the one or more users, logging events associated with the execution of the at least one drill, measuring performance associated with objectives, measuring performance of each of the one or more users, measuring performance associated with the at least one drill, observing the performance of various activities ranging from the manipulation of simulator equipment to the decision-making abilities of the users, and so forth. Based on the analysis, analysis result data may be obtained.

In example embodiments, the method 300 may further include providing, by the processing unit, a messaging interface to the one or more users and the administrator. The processing unit may exchange one or more messages between each of the one or more users and the administrator via the messaging interface. More specifically, the messaging interface may be used to distribute the information across the organization through instant messaging by using the administrator device and the user devices. Drills and exercises may be urgent or rapidly changing and may require constant monitoring across various locations and timely and precise communications between the administrator and the users can be a critical factor for performance of exercises of the drills.

In an example embodiment, the administrator may need to temporarily stop execution of all or some drills (e.g., when an urgent or critical situation related to safety, actual emergency, or act of nature occurs). The administrator may provide a request to pause the execution of the drills or events and request to resume the drills or events when the situation has been resolved. Upon the request, the drill execution unit may make the drills unavailable for the users in a timeline on the user devices.

The storage unit, also referred to herein as a database, may be configured to store at least the drill parameters, the at least one drill generated by the drill creation unit, the access code, analysis result data, the data associated with the execution of the at least one drill by each of the one or more users, authentication information associated with the administrator and the one or more users, messages exchanged between each of the one or more users and the administrator, the drill execution report, and so forth. Moreover, elements of the drill may be recorded by the storage unit to facilitate analysis of execution of the drills and determine any remediation of performance.

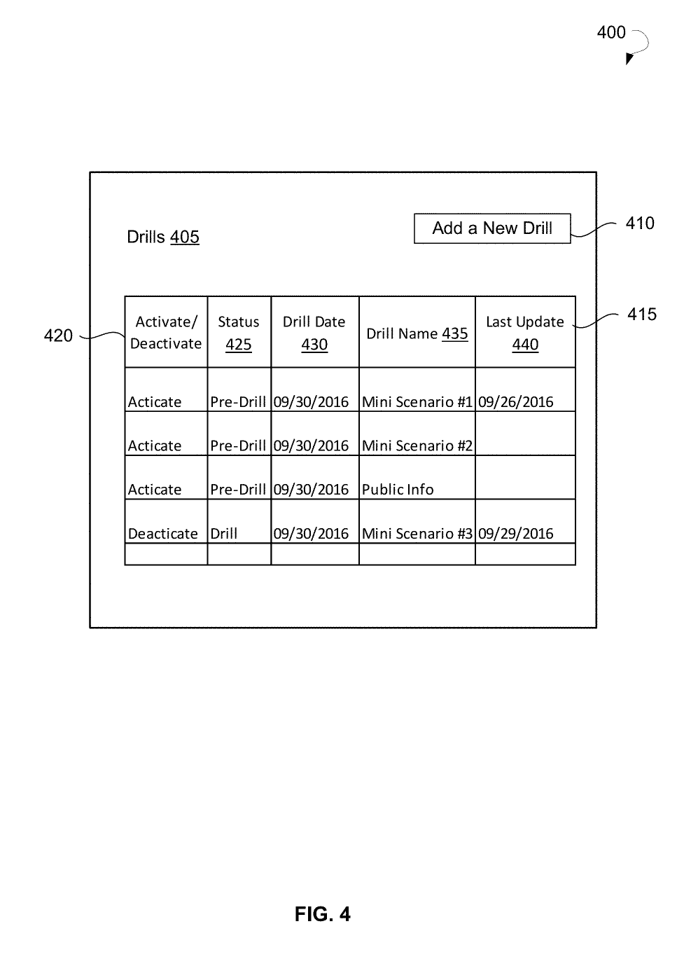

FIG. 4 is a schematic representation of a user interface 400 displaying a list of drills associated with an administrator, according to an example embodiment. Upon receipt of the authentication information, such as credentials, from the administrator, the user interface 400 may be provided to the administrator. The user interface 400 may display a table 415 containing the list of drills 405 associated with the administrator. The table 415 may include a column 420, by means of which the administrator may activate or deactivate any of the drills 405, a column showing a status 425 of the drills 405, and columns showing a drill date 430, a drill name 435, and last update 440. The status 425 may show whether the administrator has already created the drill (such status may be shown as “drill”) or whether the creation of the drill is not completed (such status may be shown as “pre-drill”). The drill date 430 may include the intended date of execution of the drills 405. The drill name 435 may be composed and entered by the administrator. The last update 440 may include date of the last update of the drill and/or a brief description of the last update of the drill. The user interface 400 may also have ‘Add a New Drill’ button 410. The administrator may select the ‘Add a New Drill’ button 410 for creation of a drill.

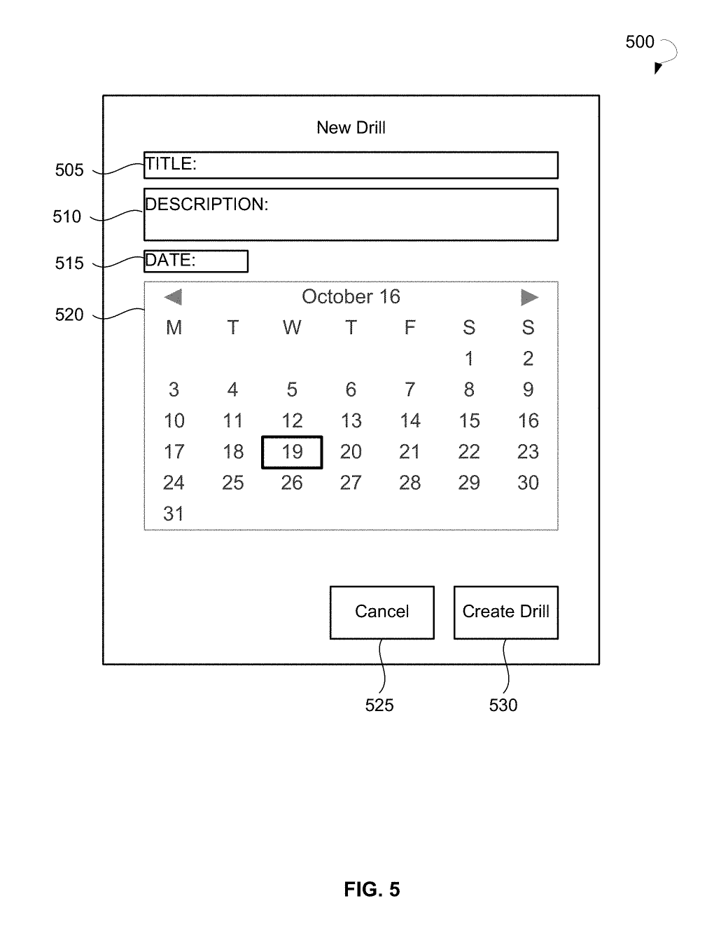

FIG. 5 is a schematic representation of a user interface 500 for creation of a drill by the administrator, according to an example embodiment. When the administrator selects the ‘Add a New Drill’ button 410 as shown on FIG. 4, the user interface 500 may be displayed to the administrator. The administrator may fill in fields on the user interface 500. For example, the administrator may enter a name of the drill into a field 505, enter a description of the drill into a field 510, enter a date into a field 515, or select the date in a calendar 520. The user interface 500 may also have a ‘Cancel’ button 525 by which the administrator may cancel the creation of the drill and a ‘Create Drill’ button 530 by which the administrator may finish the creation of the drill. In an example embodiment, the user interface 500 may have other fields or buttons not shown on FIG. 5.

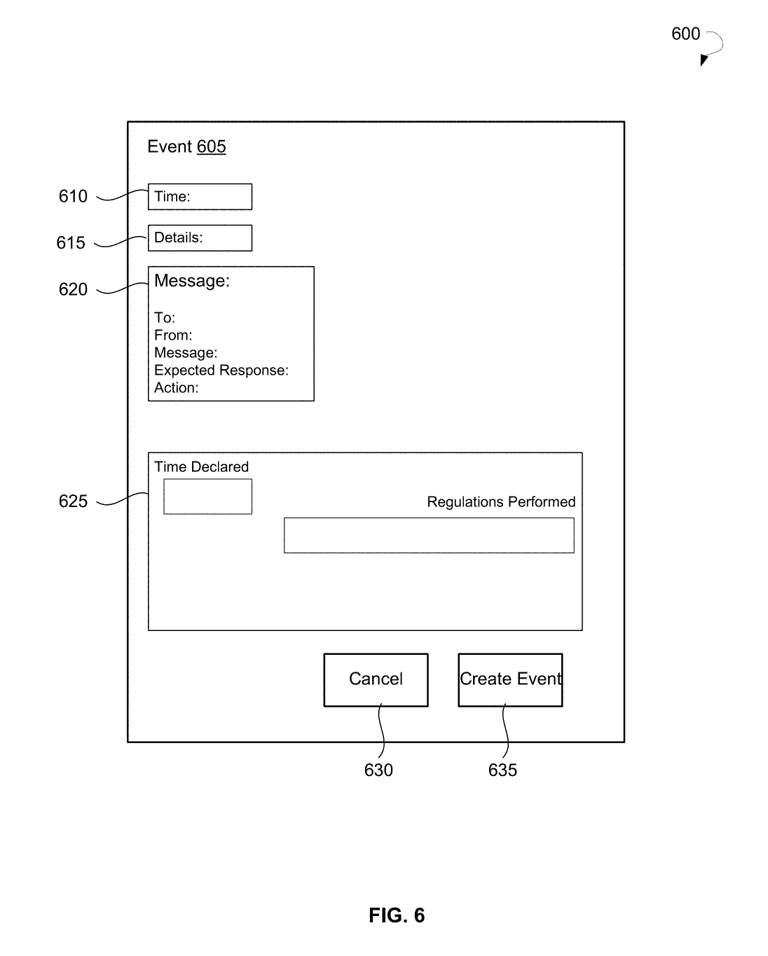

FIG. 6 is a schematic representation of a user interface 600 showing creation of an event associated with a drill, according to an example embodiment. The event may include performing of an exercise associated with the drill by the users, receiving information associated with the drill by the users, practicing actions by the users, and so forth. During the creation of the event 605, the administrator may enter time 610 of execution of the event 605, details 615 associated with the event 605, and a message 620 associated with the event 605. The message 620 may include persons to whom the event 605 relates, a name or a position of a person that created the event 605, a message to be delivered to intended users during the execution of the event 605, an action to be taken by the users during the execution of the drill or by the administrator after the drill is executed, an expected response (i.e., a response expected to be received from the users that execute the drill), and regulatory information 625. The message designed for delivery to the intended users during the drill may be scheduled in the timeline, thereby providing a straightforward guide for the users to performing the drill. The regulatory information 625 may include statutory acts according to which the drill needs to be performed, a time declared for the event, and any other regulatory information. The user interface 600 may also have a ‘Cancel’ button 630 by which the administrator may cancel the creation of the event and a ‘Create Event’ button 635 by which the administrator may finish the creation of the event. In an example embodiment, the user interface 600 may have other fields or buttons not shown on FIG. 6.

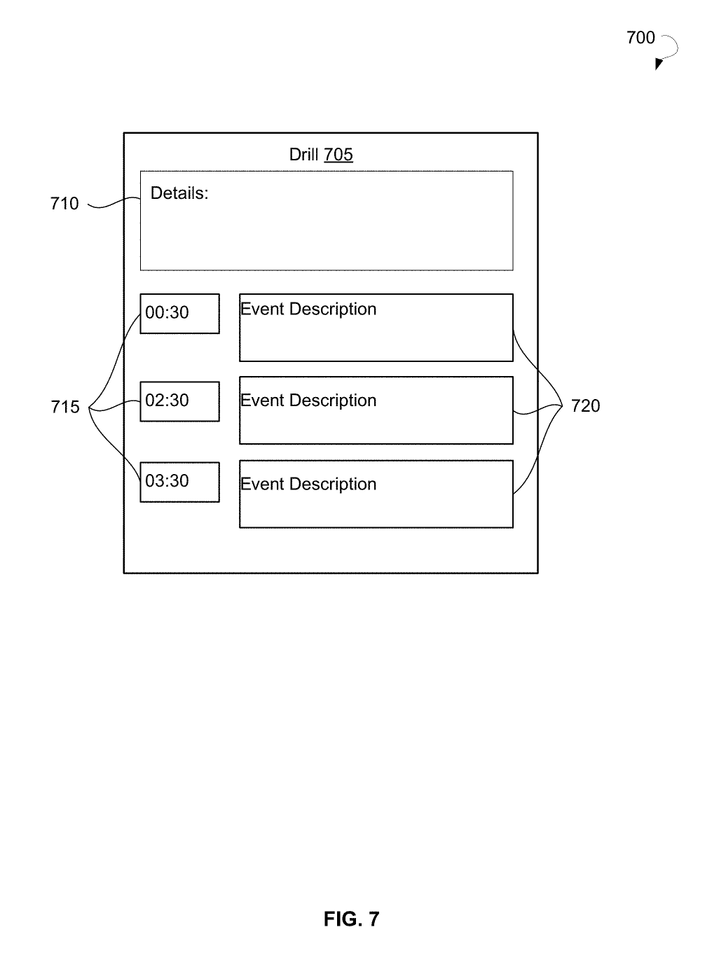

FIG. 7 is a schematic representation of a user interface 700 showing a list of events associated with a drill, according to an example embodiment. When the events associated with a drill 705 are added by the administrator, the user interface 700 may be displayed to the administrator. The user interface 700 may show details 710 of the drill 705, and time 715 and description 720 associated with each of the events.

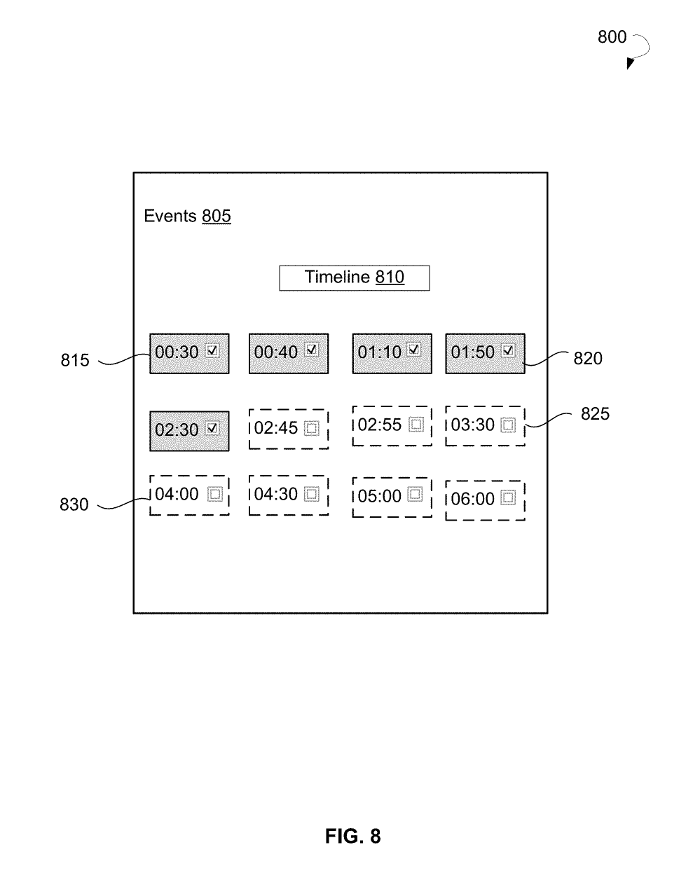

FIG. 8 is a schematic representation of a user interface 800 showing events of a drill, according to an example embodiment. When a user enters an access code associated with the drill as described above with reference to FIG. 3, the user interface 800 may be displayed to the user. The user interface 800 may show events 805 to be performed by the user during the execution of the drill. The events 805 may be represented according to a timeline 810. The timeline 810 maybe easily accessible from the user interface 800, and the details of each of the events may be accessed by clicking each of the events 815, 820, 825, and 830. The events that are already executed by the user may be visually indicated for quick reference (e.g., may be color-coded or may have a specific type of icons, such as shown for events 815 and 820). The events that are not yet executed by the user also may be visually indicated (e.g., by another color or another specific type of icons, such as shown for events 825 and 830).

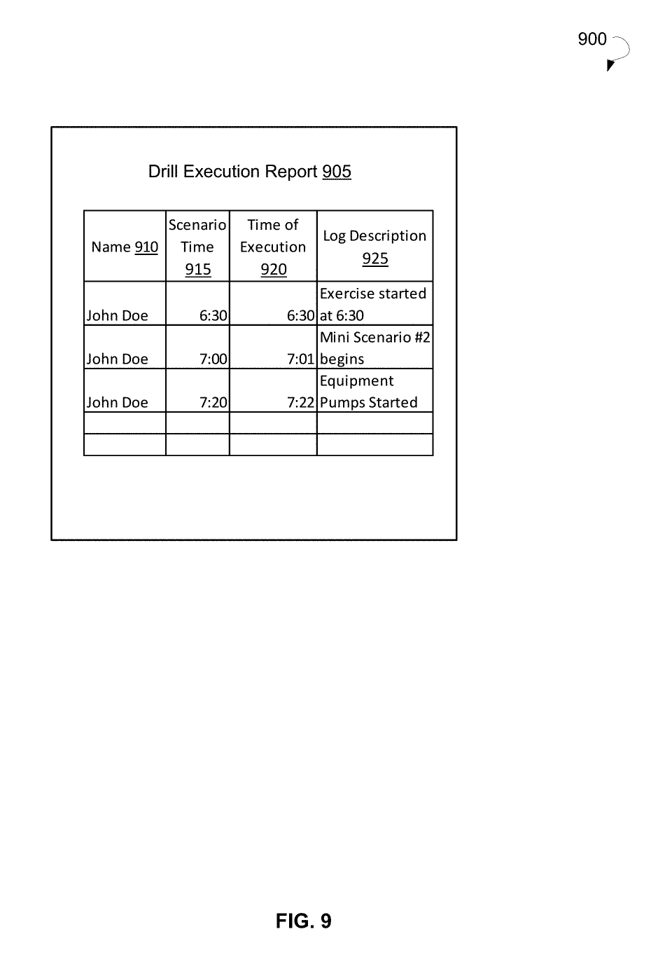

FIG. 9 is a schematic representation of a user interface 900 showing a drill execution report 905, according to an example embodiment. In the course of the execution of a drill by one or more users, a processing unit may store chronological event logs into a storage unit. Therefore, exercises performed by the users during the events may be logged across the organization of the users and may be consolidated into the drill execution report 905 and customized to particular specifications.

Upon execution of the drill by one or more users, the drill execution report 905 may be displayed to the administrator. The drill execution report 905 may include a name 910 of the user that executed the drill, a scenario time 915 (i.e., predetermined time of execution of the drill by the user), time 920 of execution of the drill, and log description 925. Furthermore, logging of the events and adding the logs into the drill execution report 905 allows documenting the progression of the drills or exercises. In example embodiments, the drill execution report 905 may further include performance indicators, e.g., emergency action levels, showing a grade of performance of the drill by the users. The performance indicators may be tracked and measured by the processing unit for providing timeliness and accuracy of the execution of the drills. In a further example embodiment, the drill execution report 905 may include all logged information associated with the users (e.g., notes the users have taken during the execution of the drill), the grading of the objectives (e.g., satisfactory, needs improvement, unsatisfactory, etc.), the grading of drill and exercise performance (DEP) risk significant planning standards which are federally regulated (e.g., satisfactory or unsatisfactory), and so forth. In an example embodiment, the administrator may visually monitor the execution of the drill by one or more users and may grade the performance of the users by using the administrator device to submit the grading information to the processing unit. Additionally, the administrator may take notes related to the performance of the users to facilitate further grading of the users.

The drill execution report 905 may be exported into a spreadsheet in Microsoft Word, Microsoft Excel, PDF, or any other format and may be provided to the administrator. In an example embodiment, the exported document may be sent to the administrator or any other persons by email.

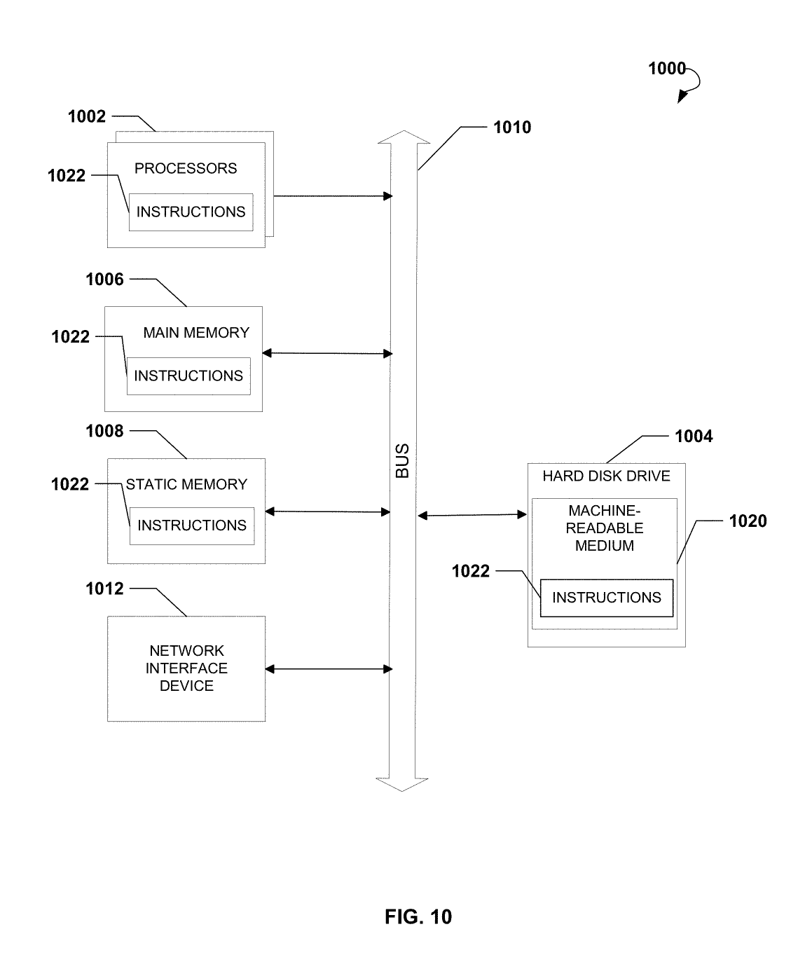

FIG. 10 shows a diagrammatic representation of a computing device for a machine in the exemplary electronic form of a computer system 1000, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box, a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1000 may include a processor or multiple processors 1002, a hard disk drive 1004, a main memory 1006 and a static memory 1008, which communicate with each other via a bus 1010. The computer system 1000 may also include a network interface device 1012. The hard disk drive 1004 may include a computer-readable medium 1020, which stores one or more sets of instructions 1022 embodying or utilized by any one or more of the methodologies or functions described herein. The instructions 1022 can also reside, completely or at least partially, within the main memory 1006 and/or within the processors 1002 during execution thereof by the computer system 1000. The main memory 1006 and the processors 1002 also constitute machine-readable media.

While the computer-readable medium 1020 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory, Read-Only Memory, and the like.

The example embodiments described herein may be implemented in an operating environment comprising software installed on a computer, in hardware, or in a combination of software and hardware.

In some embodiments, the computer system 1000 may be implemented as a cloud-based computing environment, such as a virtual machine operating within a computing cloud. In other embodiments, the computer system 1000 may itself include a cloud-based computing environment, where the functionalities of the computer system 1000 are executed in a distributed fashion. Thus, the computer system 1000, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 1000, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

Thus, methods and systems for creation and execution of drills have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A system for creation and execution of drills, the system comprising:
a drill creation unit operable to:
receive, from an administrator, via an administrator device, drill parameters;
based on the drill parameters, generate at least one drill;
generate an access code associated with the at least one drill; and
provide the access code associated with the at least one drill to the administrator to be disseminated by the administrator to one or more users;
a drill execution unit operable to:
receive, via a user device, a request from a user of the one or more users, the request including providing, by the user, the access code associated with the at least one drill; and
responsive to the request, provide the at least one drill associated with the access code to the user via the user device for an execution of the at least one drill by the user;
a processing unit operable to collect data associated with the execution of the at least one drill by the user; and
a storage unit operable to store at least the drill parameters, the at least one drill, and the access code.

2. The system of claim 1, wherein the drill creation unit is further operable to:
receive, from the administrator, an activation request to activate the at least one drill, the access code being generated based on the activation request.

3. The system of claim 1, wherein the processing unit is further operable to:
generate, based on the data associated with the execution of the at least one drill by each of the one or more users, a drill execution report; and
provide the drill execution report to the administrator, via the administrator device.

4. The system of claim 3, wherein the processing unit is further operable to:
analyze, based on predefined rules, the data associated with the execution of the at least one drill by each of the one or more users to obtain analysis result data; and
add the analysis result data to the drill execution report.

5. The system of claim 4, wherein the analyzing includes one or more of the following:
tracking performance indicators associated with the execution of the at least one drill by the one or more users;
logging events associated with the execution of the at least one drill;
measuring performance associated with objectives;
measuring performance of each of the one or more users; and
measuring performance associated with the at least one drill.

6. The system of claim 1, wherein the drill execution unit is further operable to:
upon receipt of the access code from the user, prompt the user to enter authentication information associated with the user, the authentication information including at least credentials associated with the user.

7. The system of claim 1, wherein the processing unit is further operable to:
provide a messaging interface to the one or more users and the administrator; and
exchange one or more messages between each of the one or more users and the administrator via the messaging interface.

8. The system of claim 1, wherein the drill parameters include one or more of the following: a name associated with the at least one drill, a description associated with the at least one drill, a date for the execution of the at least one drill, an event associated with the at least one drill, a message associated with the at least one drill, objective templates associated with the at least one drill, and criteria for grading objectives associated with the objective templates.

9. The system of claim 1, wherein the at least one drill is associated with one or more of the following: developing skills associated with manipulation of an equipment, developing decision-making abilities of the one or more users, scheduling actions to be performed by the one or more users, studying information by the one or more users, and practicing actions by the one or more users.

10. The system of claim 1, wherein the receiving the drill parameters further includes receiving one or more documents associated with the at least one drill, the one or more documents being uploaded by the administrator.

11. A method for creation and execution of drills, the method comprising:
receiving, by a drill creation unit, from an administrator, via an administrator device, drill parameters;
based on the drill parameters, generating, by the drill creation unit, at least one drill;
generating, by the drill creation unit, an access code associated with the at least one drill;
providing, by the drill creation unit, the access code associated with the at least one drill to the administrator to be disseminated by the administrator to one or more users;
receiving, by a drill execution unit, a request from a user of the one or more users, the request including providing, by the user, via a user device, the access code associated with the at least one drill;
responsive to the request, providing, by the drill execution unit, the at least one drill associated with the access code to the user via the user device for an execution of the at least one drill by the user; and
collecting, by a processing unit, data associated with the execution of the at least one drill by the user.

12. The method of claim 11, wherein the at least one drill includes a drill package, the drill package including a plurality of drills to be executed by the user.

13. The method of claim 11, further comprising:
receiving, by the drill creation unit, from the administrator, an activation request to activate the at least one drill, the access code being generated based on the activation request.

14. The method of claim 11, further comprising:
generating, by the processing unit, based on the data associated with the execution of the at least one drill by each of the one or more users, a drill execution report; and
providing, by the processing unit, the drill execution report to the administrator, via the administrator device.

15. The method of claim 14, further comprising:
analyzing, by the processing unit, based on predefined rules, the data associated with the execution of the at least one drill by each of the one or more users to obtain analysis result data; and
adding, by the processing unit, the analysis result data to the drill execution report.

16. The method of claim 11, further comprising:
upon receipt of the access code from the user, prompting, by the drill execution unit, the user to enter authentication information associated with the user, the authentication information including at least credentials associated with the user.

17. The method of claim 11, wherein the receiving the drill parameters further includes receiving one or more documents associated with the at least one drill, the one or more documents being uploaded by the administrator.

18. The method of claim 11, further comprising:
providing, by the processing unit, a messaging interface to the one or more users and the administrator; and
exchanging, by the processing unit, one or more messages between each of the one or more users and the administrator via the messaging interface.

19. The method of claim 11, wherein the access code is disseminated by the administrator to the one or more users using one or more of the following: sending the access code via e-mail, sending the access code to an organization network associated with the administrator and the one or more users, enabling the administrator to provide the access code to the one or more users, providing the access code via an announcement board of an organization associated with the administrator and the one or more users, and providing the access code via a messaging agent associated with the organization.

20. A system for creation and execution of drills, the system comprising:
a drill creation unit operable to:
receive, from an administrator, via an administrator device, drill parameters;
based on the drill parameters, generate at least one drill;
receive, from the administrator, an activation request to activate the at least one drill;
based on the activation request, generate an access code associated with the at least one drill; and
provide the access code associated with the at least one drill to the administrator to be disseminated by the administrator to one or more users;
a drill execution unit operable to:
receive, via a user device, a request from a user of the one or more users, the request including providing, by the user, the access code associated with the at least one drill;
responsive to the request, provide the at least one drill associated with the access code to the user via the user device for an execution of the at least one drill by the user; and
upon receipt of the access code from the user, prompt the user to enter authentication information associated with the user, the authentication information including at least credentials associated with the user;
a processing unit operable to:
collect data associated with the execution of the at least one drill by the user;
generate, based on the data associated with the execution of the at least one drill by each of the one or more users, a drill execution report;
provide the drill execution report to the administrator, via the administrator device;
analyze, based on predefined rules, the data associated with the execution of the at least one drill by each of the one or more users to obtain analysis result data; and
add the analysis result data to the drill execution report; and
a storage unit operable to store at least the drill parameters, the at least one drill, and the access code.
